(19) United States
(12) Patent Application Publication
(10) Pub. No.: US 2009/0305621 A1
(43) Pub. Date: Dec. 10, 2009

(54) HEIGHT-ADJUSTABLE DEVICE FOR AN EXTRACTOR HOOD WHICH IS FIXED TO A COVER AND EXTRACTOR

(75) Inventors: Gerd Eckardt, Sundern (DE); Heinz-Gerd Nolte, Amsberg (DE); Dirk Schuesseler, Arnsberg (DE); Friedrich Walloth, Amsberg (DE)

Correspondence Address: DARBY & DARBY P.C., P.O. BOX 770, Church Street Station, New York, NY, 10008-0770, US

(73) Assignee: Miele & Cie. KG, Guetersloh (DE)

(21) Appl. No.: 11/574,453

(22) PCT Filed: Aug. 16, 2005
(86) PCT No.: PCT/EP05/08880

§ 371 Date: Feb. 28, 2007

(30) Foreign Application Priority Data
Sep. 1, 2004 (DE) 10 2004 042 291.5

(51) Int. Cl. B08B 15/02; F16M 13/00

(52) U.S. Cl. 454/63; 248/336

(57) ABSTRACT

A height-adjustment device for a ceiling-mounted exhaust hood includes a guide bar, a detent pawl and a snapping disposed on the detent pawl. The guide bar includes a plurality of notches and is disposed on a first part of the exhaust hood. The detent pawl is disposed on a second part of the exhaust hood. The first and second parts of the exhaust hood are movable relative to one another. The detent pawl, when moved along a longitudinal axis of the guide bar in a first direction is automatically movable from an unlocked position to a locked position by an interaction of the snapping device with a first actuating device. The detent pawl, when moved in a second direction along the longitudinal axis, is automatically movable from the locked position to the unlocked position by an interaction of the snapping device with a second actuating device.

### CROSS REFERENCE TO PRIOR APPLICATION

This is a U.S. national phase application under 35 U.S.C. §371 of International Patent Application No. PCT/EP2005/008880, filed Aug. 16, 2005, and claims benefit of German Patent Application No. 10 2004 042 291.5, filed Sep. 1, 2004, which is incorporated by reference herein. The International Application was published in German on Mar. 9, 2006 as WO 2006/024391 A1 under PCT Article 21(2).

The present invention relates to a height-adjustment device for a ceiling-mounted exhaust hood, the height-adjustment device including at least one a guide bar provided with notches and further including a detent pawl, the guide bar and detent pawl, when the height-adjustment device is in a mounted state, being mounted to two parts of an exhaust hood that are movable relative to one another.

### BACKGROUND

A height-adjustment device is described, for example, in WO 02/093079 A1. The exhaust hood disclosed therein has a height-adjustment device including a guide bar which is in the form of a toothed bar and is provided with notches, and further including a detent pawl. When the height-adjustment device is in the mounted state, the guide bar is attached to a wall-mounting plate and the detent pawl is attached to the rest of the known exhaust hood. The detent pawl is movable from an unlocked position, in which the detent pawl can be moved along the longitudinal axis of the guide bar, to a locked position, in which the detent pawl lockingly engages with the notches of the guide bar, so that the detent pawl is prevented from moving along the longitudinal axis of the guide bar. In the described height-adjustment device, the detent pawl is automatically held in the locked position by a biased spring member. The user can move the detent pawl from the locked position to the unlocked position against the force of the spring means by pulling on a cable attached to the detent pawl, after which the user can adjust the vertical position of the known exhaust hood while keeping the cable tensioned. Once the exhaust hood is at the desired height, the user releases the cable, whereupon the detent pawl is automatically moved back to the locked position by the force of the spring means.

### SUMMARY

In view of the above, it is an object of the present invention to provide a height-adjustment device for a ceiling-mounted exhaust hood, which increases the ease of height adjustment.

The present invention provides a height-adjustment device for a ceiling-mounted exhaust hood. The height-adjustment device includes: a guide bar including a plurality of notches, the guide bar being disposed on a first part of the exhaust hood when the height adjustment device is in a mounted state; a detent pawl disposed on a second part of the exhaust hood when the height adjustment device is in the mounted state; and a snapping device disposed on the detent pawl. The first and second parts of the exhaust hood are movable relative to one another. The detent pawl is movable from an unlocked position to a locked position, in the unlocked position the detent pawl being movable along a longitudinal axis of the guide bar, in the locked position, the detent pawl lockingly engaging a respective notch of the notches of the guide bar so as to prevent the detent pawl from moving along the longitudinal axis in a first direction and permit the detent pawl to move in a second direction opposite the first direction. The guide bar includes a first actuating device disposed at a first end region thereof and a second actuating device disposed at a second end region thereof. When the height-adjustment device is in the mounted state, the detent pawl, when moved along the longitudinal axis in the first direction is automatically movable from the unlocked position to the locked position by an interaction of the snapping device with first actuating device, and the detent pawl, when moved in the second direction, is automatically movable from the locked position to the unlocked position by an interaction of the snapping device with the second actuating device.

A further, alternative object of the present invention is to provide an exhaust hood having a height-adjustment device according to the present invention.

The present invention also provides an exhaust hood including a fan housing, a chimney housing and a height-adjustment device. The height-adjustment device includes a guide bar including a plurality of notches, a detent pawl, and a snapping device disposed on the detent pawl. The fan housing and the chimney housing are movable relative to one another. The detent pawl is movable from an unlocked position to a locked position, in the unlocked position the detent pawl being movable along a longitudinal axis of the guide bar, in the locked position, the detent pawl lockingly engaging a respective notch of the notches of the guide bar so as to prevent the detent pawl from moving along the longitudinal axis in a first direction and permit the detent pawl to move in a second direction opposite the first direction. The guide bar includes a first actuating device disposed at a first end region thereof and a second actuating device disposed a second end region thereof. When the height-adjustment device is in the mounted state, the detent pawl, when moved along the longitudinal axis in the first direction is automatically movable from the unlocked position to the locked position by an interaction of the snapping device with first actuating device, and the detent pawl, when moved in the second direction, is automatically movable from the locked position to the unlocked position by an interaction of the snapping device with the second actuating device. The guide bar is disposed on the fan housing and the detent pawl is disposed on the chimney housing, or the guide bar is disposed on the chimney housing and the detent pawl is disposed on the fan housing, when the height adjustment device is in the mounted state.

### BRIEF DESCRIPTION OF THE DRAWINGS

An exemplary embodiment of the present invention is shown in the drawings in a schematic way and will be described in more detail below. In the drawings,

FIG. 1 is a perspective view of an exhaust hood according to the present invention, showing the ceiling-mounted exhaust hood in the lowermost position;

FIG. 2 is a view similar to that of FIG. 1, showing the exhaust hood of FIG. 1 with the outer chimney housing lifted up;

FIG. 3 is an enlarged view illustrating a detail of the exhaust hood of FIG. 2;

FIG. 4 is a view similar to that of FIG. 2, showing the exhaust hood of FIG. 2 without the outer chimney housing;

FIG. 5 is a partial enlarged view of the inner chimney housing of FIG. 4;

FIG. 6 is an enlarged partial front view of an inventive height-adjustment device of FIG. 4, showing the detent pawl in the unlocked position;

FIG. 7 is a view similar to that of FIG. 6, showing the inventive height-adjustment device of FIG. 6 with the detent pawl in the locked position;

FIG. 8 is a view of the exhaust hood similar to that of FIG. 4, but showing the exhaust hood in the uppermost position;

FIG. 9 is a view similar to that of FIG. 6, showing the inventive height-adjustment device in a position corresponding to that shown in FIG. 8 for the exhaust hood, and showing the detent pawl in the locked position; and

FIG. 10 is a view similar to that of FIG. 9, showing the inventive height-adjustment device of FIG. 9 with the detent pawl in the unlocked position.

### DETAILED DESCRIPTION

In addition to increasing the ease of height adjustment, a particular advantage that can be achieved with the present invention is that less force is required of the user during height adjustment. Furthermore, the user does not need to tension a cable while at the same time supporting the exhaust hood against its weight, or even moving it in a direction opposite to the weight.

In an advantageous refinement of the teaching according to the present invention, the guide bar has an elongated slot which extends parallel to the longitudinal axis thereof and in which the detent pawl is guided when the height-adjustment device is in the mounted state, one longitudinal wall of the elongated slot being provided with notches and the opposite longitudinal wall of the elongated slot being substantially flat. Thus, both functions of the guide bar, namely that of guiding the detent pawl during height-adjustment of the exhaust hood, and that of creating a latching connection with the detent pawl when the detent pawl is in the locked position, are achieved together in a structurally simple manner. Moreover, since the notches are disposed within an elongated slot, the user is protected from being injured during height adjustment by the potentially sharp edges of the notches.

In an advantageous refinement of the aforementioned embodiment, substantially the entire one longitudinal wall is provided with immediately adjacent notches. This allows for a height adjustment in small increments.

According to an advantageous refinement of the aforementioned embodiments, the detent pawl is pivotally mounted about an axis of rotation which, when the height-adjustment device is in the mounted state, extends substantially perpendicular to the plane defined by the elongated slot, and the two longitudinal walls of the elongated slot each have an actuating means in the form of a ramp-shaped section. In this manner, a simple and rugged construction is achieved for the height-adjustment device of the present invention.

In another advantageous refinement of the aforementioned embodiment, the snapping means includes a mass which is eccentrically disposed on the detent pawl at a distance from the axis of rotation. Thus, a snapping means is provided which is of particularly simple and rugged construction.

In yet another advantageous refinement of the aforementioned embodiments, the snapping means includes a spring means. This allows a detent pawl design that is lightweight and saves material.

The design of the notches unit can, in principle, be selected within wide suitable limits in terms of type, material, and arrangement. Conveniently, the notches are saw-toothed in shape.

In an advantageous refinement of the teaching according to the present invention, the height-adjustment device includes a securing means which allows the guide bar to be fixed in position relative to the detent pawl. This ensures that, after the vertical position of the exhaust hood is adjusted for the first time, said position is reliably maintained and protected from unwanted readjustment.

The arrangement of the inventive height-adjustment device on the exhaust hood of the present invention can, in principle, be selected within wide suitable limits. Conveniently, when the height-adjustment device is in the mounted state, the guide bar is attached to a fan housing and the detent pawl is attached to a chimney housing of the exhaust hood, or vice versa.

In an advantageous embodiment of the exhaust hood according to the present invention, the height-adjustment device, when in the mounted state, has two diagonally opposite, spaced-apart guide bars, which are each in engagement with a detent pawl. This improves the linear guidance of the parts of the exhaust hood that are moved relative to each other during height-adjustment, thus reducing the risk of jamming during height-adjustment.

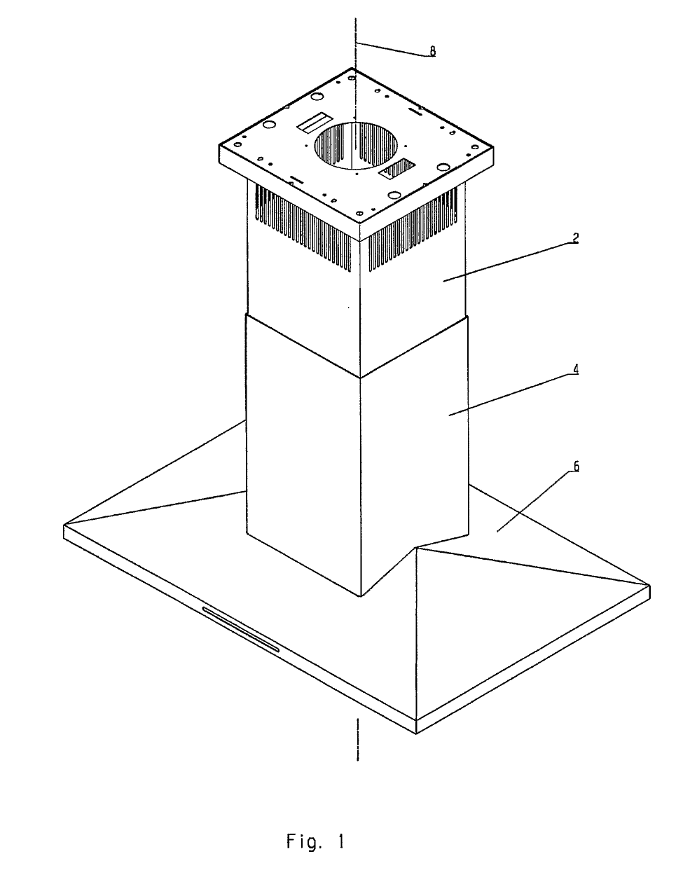

FIG. 1 shows an inventive ceiling-mounted exhaust hood having a height-adjustment device according to the present invention. The exhaust hood described herein is a recirculation hood. The following explanations are also valid for venting hoods. The ceiling to which the exhaust hood is mounted in a manner known to those skilled in the art is not shown to simplify the illustration. In FIG. 1, the exhaust hood is shown in an oblique perspective view from above. The exhaust hood includes an inner chimney housing 2, an outer chimney housing 4, and an exhaust housing 6. All housings 2, 4 and 6 are formed of sheet-metal parts. When the exhaust hood is in the assembled state, outer chimney housing 4 is guided on inner chimney housing 2 in such a manner that it is able to slide parallel to a vertical axis represented by a dot-dash line 8.

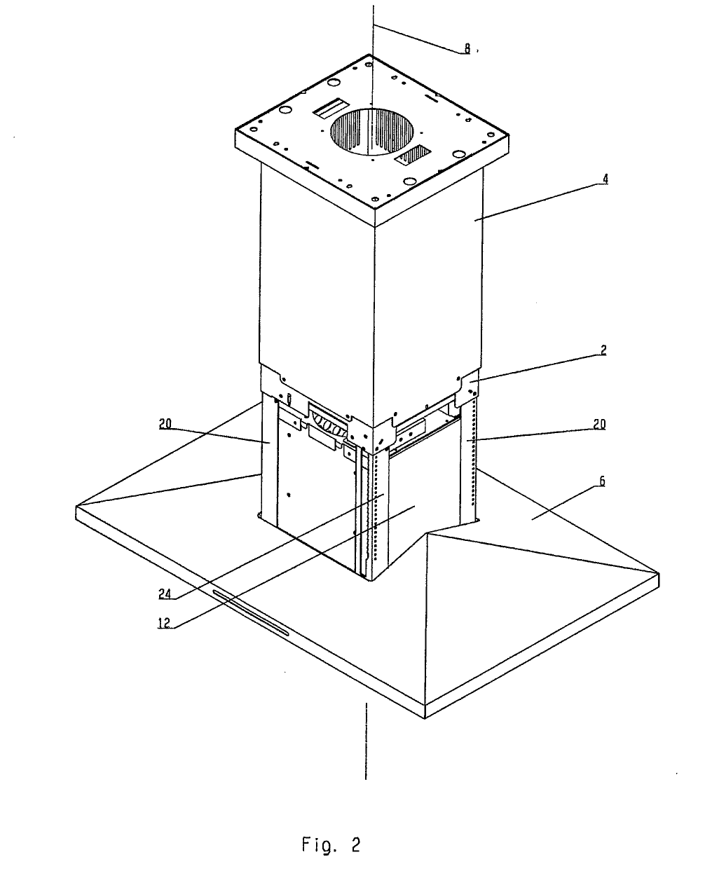

FIG. 2 shows the exhaust hood in a view similar to that of FIG. 1. In contrast to FIG. 1, the exhaust hood is shown here with the outer chimney housing 4 pushed up along inner chimney housing 2. Inner chimney housing 2 has disposed thereon a locking means (not shown in FIG. 2) in the form of a snap spring to fix outer chimney housing 4 in the uppermost position shown here.

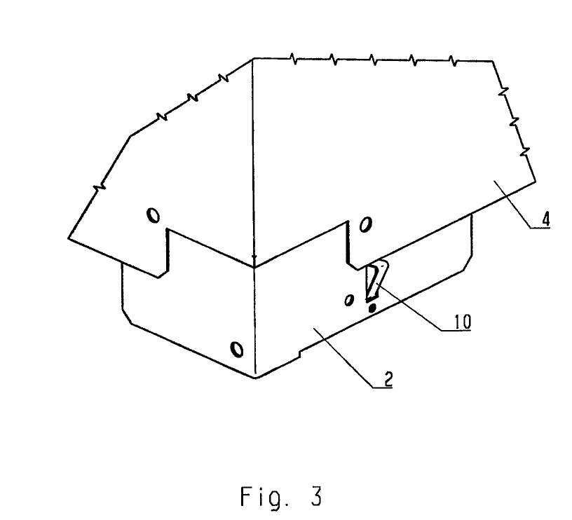

FIG. 3 is a view showing a detail of the exhaust hood of FIG. 2 in the region of locking means 10. Snap spring 10 has a downwardly tapering ramp (with respect to the image plane) which allows outer chimney housing 4 to be moved with little force and against the force of snap spring 10 in an upward direction with respect to the image plane. Once the outer chimney housing 4 has been moved to the uppermost position shown in FIG. 3, snap spring 10 returns to the relaxed position shown in FIG. 3. Snap spring 10 transfers the weight of outer chimney housing 4 to inner chimney housing 2, said inner chimney housing holding the entire exhaust hood to the ceiling.

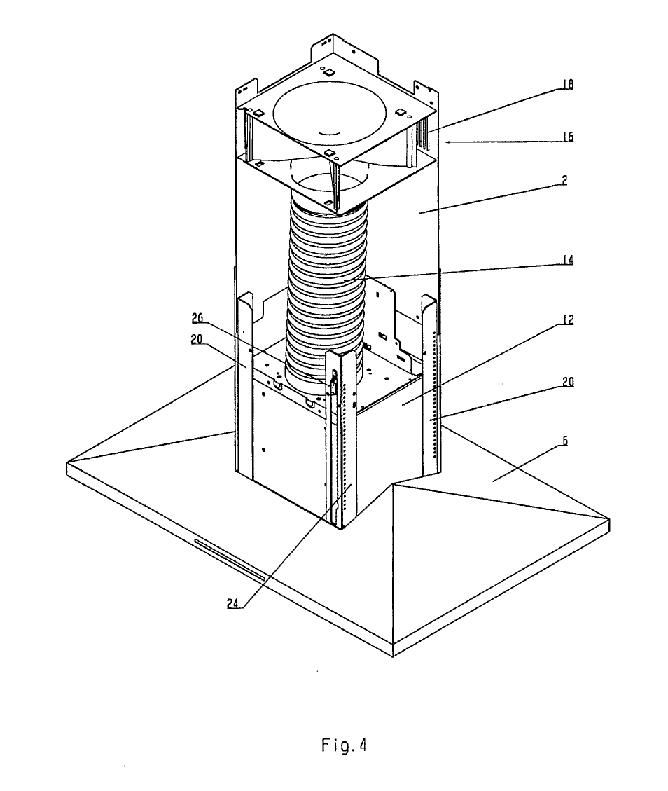

In FIG. 4, the exhaust hood according to the present invention is shown in a view analogous to that of FIG. 2. To improve clarity, outer chimney housing 4 is not shown, and inner chimney housing 2 is shown with the front portion removed (with respect to the image plane). As can be clearly seen in FIG. 4, inner chimney housing 2 accommodates a fan housing 12 and a flow channel 14 in the form of an expandable pleated exhaust duct. Flow channel 14 connects the fan outlet opening, in a manner known to those skilled in the art, to the air outlet region 16 formed in inner chimney housing 2. In the aforementioned exhaust hood, the exhaust air, which is exhausted, for example, from above a cooktop (not shown), is returned to the same room via slotted openings 18.

FIG. 5 is a view showing inner chimney housing 2 with the front portion removed (with respect to the image plane). The present exhaust hood has a total of four angle bars 20 which are disposed in the four corner regions of inner chimney housing 2 and extend along vertical axis 8. Angle bars 20 are attached to fan housing 12, which is shown in FIG. 4, and are each provided with sheet-metal angles 22 and 23 at their free ends, which are shown at the bottom with respect to the image plane. When the exhaust hood is in the assembled state, outer chimney housing 4 rests on sheet-metal angles 22. Exhaust housing 6 is held to inner chimney housing 2 by sheet-metal angles 23 and angle bars 20 by means of screws.

Two diagonally opposed, spaced-apart angle bars 20 are designed as guide bars 24. Guide bars 24 and the other angle bars 20 are made of sheet-metal angles. Furthermore, angle bars 20, and thus also guide bars 24, each have a row of holes 25, whose function will be explained hereinafter. Guide bars 24 each have an elongated slot 24.1 extending parallel to the longitudinal axis thereof. One longitudinal wall 24.2 of elongated slot 24.1 is provided with immediately adjacent saw-tooth-shaped notches 24.3 over nearly its entire length, while the other longitudinal wall 24.4 of elongated slot 24.1 is substantially flat. Inner chimney housing 2 has mounted thereto detent pawls 26 which are guided in elongated slots 24.1 of guide bars 24 and which will be described in greater detail hereinafter.

The following description provided with respect to a guide bar 24 and a detent pawl 26 applies to both of the above combinations of a guide bar 24 and a detent pawl 26.

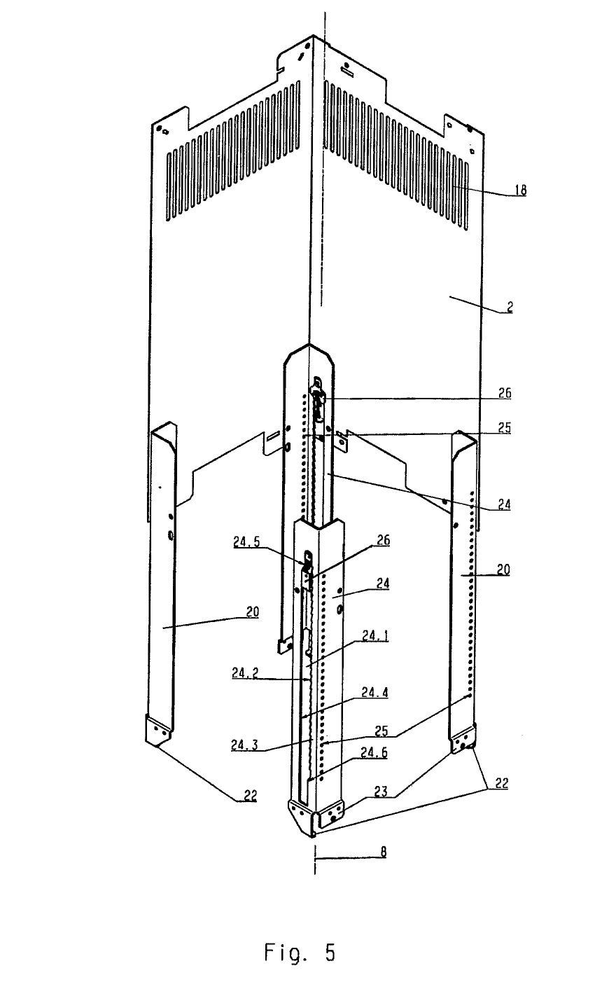

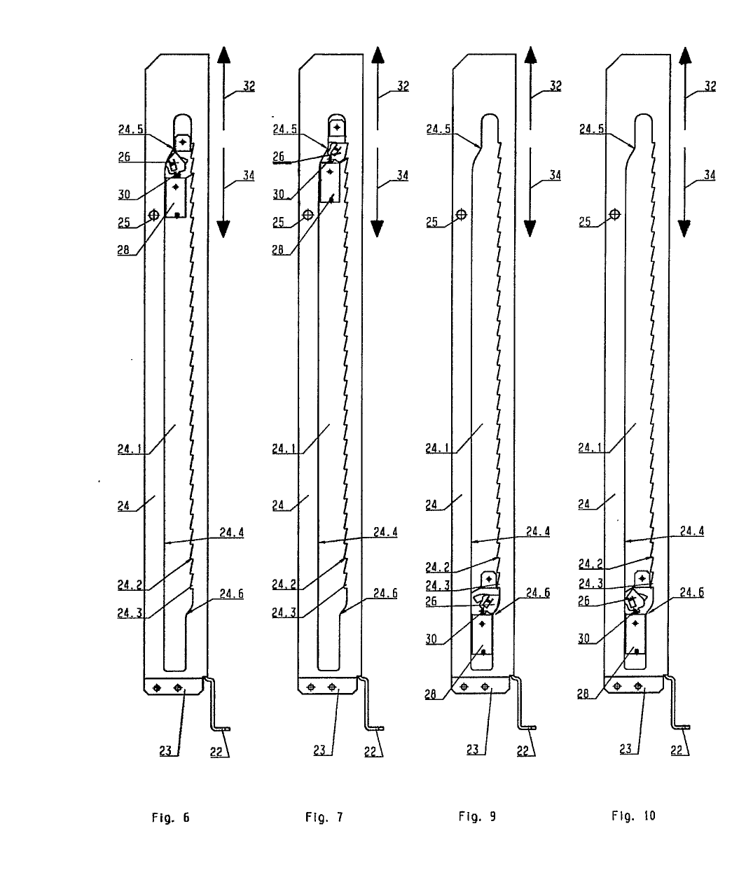

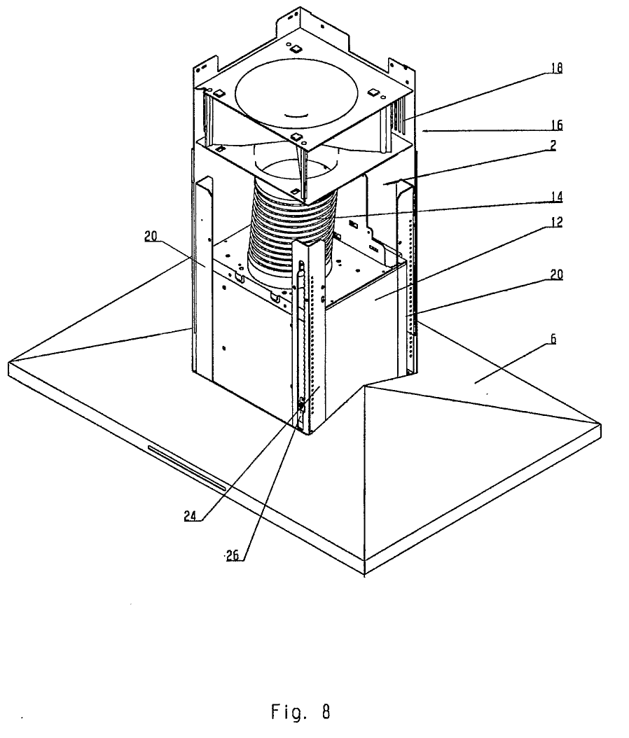

To improve clarity, FIG. 6 shows only guide bar 24 and detent pawl 26, as well as a fixing plate 28. When the exhaust hood is in the assembled state, detent pawl 26 is attached to the inner wall of inner chimney housing 2 by means of fixing plate 28. In the present exemplary embodiment, detent pawl 26 is mounted on fixing plate 28 in such a manner that it can pivot about an axis of rotation 30 which extends substantially perpendicular to guide bar 24 when the height-adjustment device is in the mounted state. In FIGS. 6, 7, 9 and 10, axis of rotation 30 extends perpendicular to the image plane. Detent pawl 26 has disposed thereon a snapping means. In the present exemplary embodiment, the snapping means includes a spring means in the form of a biased spiral spring which is held by its two ends to detent pawl 26 and fixing plate 28. The bias of the spring means causes detent pawl 26 to be moved either to an unlocked position, as shown in FIGS. 6 and 10, or to a locked position, as shown in FIGS. 7 and 9, by means of the spring force in a manner known to those skilled in the art.

The design of guide bar 24 has already been explained with reference to FIG. 5 and is shown here in an enlarged view. In the unlocked position illustrated in FIG. 6, the spring force presses detent pawl 26 against the substantially flat longitudinal wall 24.4 of elongated slot 24.1, as explained hereinabove. In this position, which is the unlocked position, detent pawl 26 is able to move along the longitudinal axis of guide bar 24 in both directions. Detent pawl 26 is nearly in the uppermost position relative to guide bar 24, which means that the ceiling-mounted exhaust hood is nearly in the lowermost position, which is shown in FIGS. 1, 2 and 4. In this position, detent pawl 26 abuts a ramp-shaped section 24.5 of longitudinal wall 24.4, said ramp-shaped section being designed as an actuating means. If the exhaust hood were moved further toward the lowermost position, detent pawl 26 would move further upward relative to guide bar 24. In this process, actuating means 24.5 would cause detent pawl 26 to pivot, in a clockwise direction (with respect to the image plane) and against the force of the spring means, about axis of rotation 30 to the locked position, which is shown in FIG. 7. In FIGS. 6, 7, 9 and 10, the rows of holes 25 are indicated only by the uppermost hole (with respect to the image plane).

FIG. 7 shows detent pawl 26 in the locked position, in which detent pawl 26 abuts against the longitudinal wall 24.2, which carries notches 24.3, of elongated slot 24.1 and is in locking engagement with the uppermost notch (with respect to the image plane). In this position, which is the locked position, detent pawl 26 is prevented from moving along the longitudinal axis of guide bar 24 in the direction of arrow 32 but is able to move in the direction of arrow 34. When moving the exhaust hood from the lowermost position illustrated in FIGS. 1, 2 and 4 to the uppermost position shown in FIG. 8, detent pawl 26 moves in the direction of arrow 34, i.e., in a downward direction (with respect to the image plane in FIG. 7).

When detent pawl 26 has moved in the direction of arrow 34 and assumed the position shown in FIG. 9, detent pawl 26 is nearly in the lowermost position relative to guide bar 24. In this position, detent pawl 26 abuts a ramp-shaped section 24.6 of longitudinal wall 24.2, said ramp-shaped section being designed as an actuating means. If the exhaust hood were moved further toward the uppermost position, detent pawl 26 would move further downward relative to guide bar 24. In this process, actuating means 24.6 would cause detent pawl 26 to pivot, in a counterclockwise direction (with respect to the image plane) and against the force of the spring means of the snapping means, about axis of rotation 30 to the unlocked position, which is shown in FIG. 10. Detent pawl 26 can be moved again in both directions along the longitudinal axis of guide bar 24, so that detent pawl 26 can be moved in the direction of arrow 32 again, which means that the exhaust hood can be moved to the lowermost position again.

In the following, the operation of the inventive height-adjustment device and the exhaust hood according to the present invention will be explained in greater detail with reference to the Figures.

The exhaust hood is mounted to the ceiling and is in the vertical position shown in FIGS. 1 and 7. During height adjustment, first, outer chimney housing 4 is pushed upward on inner chimney housing 2 until outer chimney housing 4 clears snap spring 10, allowing it to assume the relaxed position illustrated in FIG. 3. Snap spring 10 retains outer chimney housing 4 in the uppermost position. The exhaust hood is now in the condition illustrated in FIG. 2. Fan housing 12, along with the angle bars 20 and guide bars 24 attached thereto, is detachably connected to inner chimney housing 2 by means of screws screwed into the rows of holes 25 and into inner chimney housing 2. The aforementioned screw connection constitutes a securing means which allows guide bars 24 to be fixed in position relative to detent pawls 26. To be able to make a height adjustment, it is necessary to loosen the screws, so that, during the height adjustment period, fan housing 12 and exhaust housing 6 are retained on inner chimney housing 2 only by the interlocking connection between guide bars 24 and detent pawls 26.

When the screw connections are loosened, the exhaust hood is manually moved from the lowermost position to the desired position between the lowermost and uppermost positions. In the process, detent pawl 26, which is in the locked position, moves from notch 24.3 to notch 24.3 in the direction of arrow 34, as already explained with reference to FIGS. 7 and 9. Once the desired vertical position of the exhaust hood is reached, the aforementioned screw connection is created again and outer chimney housing 4 is lowered on inner chimney housing 2 until it rests on mounting angles 22. If the height adjustment is to be made again, the aforementioned steps need to be repeated. Since detent pawl 26, when locked in the last-mentioned position, cannot be moved in the direction of arrow 32, and thus the exhaust hood cannot be lowered, it is necessary to move the exhaust hood fully to the uppermost position shown in FIGS. 8 and 10. In the process, detent pawl 26 is moved from the locked position to the unlocked position, as explained above with reference to FIGS. 9 and 10. Detent pawl 26 is in the unlocked position, so that the exhaust hood can now be fully lowered to the lowermost position. In the process, detent pawl 26 is moved from the unlocked position to the locked position, as has been explained with reference to FIGS. 6 and 7. The height adjustment can be repeated as explained above.

The teaching of the present invention is not limited to the exemplary embodiment described above. Reference should be had to the appended claims. For example, it is possible to use other suitable joining techniques and materials known to those skilled in the art. Furthermore, the snapping means can also take the form of a mass eccentrically disposed on detent pawl 26 at a distance from axis of rotation 30, without a spring means being alternatively or additionally used. In a departure from the above exemplary embodiment, the height-adjustment device of the present invention can also be used for exhaust hoods having an exterior wall fan. In this case, angle bars 20 and guide bars 24 would be attached, for example, directly to exhaust housing 6.

1-10. (canceled)

11. A height-adjustment device for a ceiling-mounted exhaust hood, the height-adjustment device comprising:
a guide bar including a plurality of notches, the guide bar being disposed on a first part of the exhaust hood when the height adjustment device is in a mounted state;
a detent pawl disposed on a second part of the exhaust hood when the height adjustment device is in the mounted state; and
a snapping device disposed on the detent pawl;
wherein:
the first and second parts of the exhaust hood are movable relative to one another;
the detent pawl is movable from an unlocked position to a locked position, in the unlocked position the detent pawl being movable along a longitudinal axis of the guide bar, in the locked position, the detent pawl lockingly engaging a respective notch of the notches of the guide bar so as to prevent the detent pawl from moving along the longitudinal axis in a first direction and permit the detent pawl to move in a second direction opposite the first direction;
the guide bar includes a first actuating device disposed at a first end region thereof and a second actuating device disposed at a second end region thereof; and
when the height-adjustment device is in the mounted state, the detent pawl, when moved along the longitudinal axis in the first direction is automatically movable from the unlocked position to the locked position by an interaction of the snapping device with first actuating device, and the detent pawl, when moved in the second direction, is automatically movable from the locked position to the unlocked position by an interaction of the snapping device with the second actuating device.

12. The height-adjustment device as recited in claim 11 wherein the guide bar includes an elongated slot extending parallel to the longitudinal axis, the detent pawl being guided in the elongated slot when the height-adjustment device is in the mounted state, a first longitudinal wall of the elongated slot including the notches, and a second longitudinal wall of the elongated slot opposite the first longitudinal wall being substantially flat.

13. The height-adjustment device as recited in claim 12 wherein the notches are disposed adjacent each other along substantially the entire first longitudinal wall.

14. The height-adjustment device as recited in claim 12 wherein:
the detent pawl is pivotally disposed about an axis of rotation extending, when the height-adjustment device is in the mounted state, substantially perpendicular to a plane defined by the elongated slot;
the first longitudinal wall of the elongated slot includes the second actuating device;
the second longitudinal wall of the elongated slot includes the first actuating device; and
each of the first and second actuating devices includes a respective ramp-shaped section.

15. The height-adjustment device as recited in claim 13 wherein:
the detent pawl is pivotally disposed about an axis of rotation extending, when the height-adjustment device is in the mounted state, substantially perpendicular to a plane defined by the elongated slot;
the first longitudinal wall of the elongated slot includes the second actuating device;
the second longitudinal wall of the elongated slot includes the first actuating device; and
each of the first and second actuating devices includes a respective ramp-shaped section.

16. The height-adjustment device as recited in claim 14 wherein the snapping device includes a mass eccentrically disposed on the detent pawl at a distance from the axis of rotation.

17. The height-adjustment device as recited in claim 15 wherein the snapping device includes a mass eccentrically disposed on the detent pawl at a distance from the axis of rotation.

18. The height-adjustment device as recited in claim 14 wherein the snapping device includes a spring.

19. The height-adjustment device as recited in claim 15 wherein the snapping device includes a spring.

20. The height-adjustment device as recited in claim 16 wherein the snapping device includes a spring.

21. The height-adjustment device as recited in claim 17 wherein the snapping device includes a spring.

22. The height-adjustment device as recited in claim 11 wherein the notches include a saw-toothed shape.

23. The height-adjustment device as recited in claim 11 further comprising a securing device configured to fix the guide bar in position relative to the detent pawl.

24. An exhaust hood comprising:
a fan housing;
a chimney housing; and
a height-adjustment device including:
a guide bar including a plurality of notches,
a detent pawl; and
a snapping device disposed on the detent pawl;
wherein:
the fan housing and the chimney housing are movable relative to one another;
the detent pawl is movable from an unlocked position to a locked position, in the unlocked position the detent pawl being movable along a longitudinal axis of the guide bar, in the locked position, the detent pawl lockingly engaging a respective notch of the notches of the guide bar so as to prevent the detent pawl from moving along the longitudinal axis in a first direction and permit the detent pawl to move in a second direction opposite the first direction;
the guide bar includes a first actuating device disposed at a first end region thereof and a second actuating device disposed a second end region thereof;
when the height-adjustment device is in the mounted state, the detent pawl, when moved along the longitudinal axis in the first direction is automatically movable from the unlocked position to the locked position by an interaction of the snapping device with first actuating device, and the detent pawl, when moved in the second direction, is automatically movable from the locked position to the unlocked position by an interaction of the snapping device with the second actuating device; and
the guide bar is disposed on the fan housing and the detent pawl is disposed on the chimney housing, or the guide bar is disposed on the chimney housing and the detent pawl is disposed on the fan housing, when the height adjustment device is in the mounted state.

25. The exhaust hood as recited in claim 24 wherein the guide bar includes an elongated slot extending parallel to the longitudinal axis, the detent pawl being guided in the elongated slot when the height-adjustment device is in the mounted state, a first longitudinal wall of the elongated slot including the notches, and a second longitudinal wall of the elongated slot opposite the first longitudinal wall being substantially flat.

26. The exhaust hood as recited in claim 24 wherein:
the detent pawl is pivotally disposed about an axis of rotation extending, when the height-adjustment device is in the mounted state, substantially perpendicular to a plane defined by the elongated slot;
the first longitudinal wall of the elongated slot includes the second actuating device;
the second longitudinal wall of the elongated slot includes the first actuating device; and
each of the first and second actuating devices includes a respective ramp-shaped section.

27. The exhaust hood as recited in claim 24 wherein:
the height-adjustment device includes a second guide bar and a second detent pawl engageable with the second guide bar; and
when the height-adjustment device is in the mounted state, the guide bar and the second guide bar are diagonally disposed spaced-apart opposite each other.
